(19) United States
(12) Patent Application Publication
(10) Pub. No.: US 2026/0338721 A1
(43) Pub. Date: Oct. 29, 2026

(54) APPARATUSES FOR AND METHODS OF MEASURING THERMAL CONDUCTIVITY

(71) Applicant: Owens Corning Intellectual Capital, LLC, Toledo, OH (US)

(72) Inventor: Clinton Todd Frysinger, Johnstown, OH (US)

(21) Appl. No.: 19/110,215

(22) PCT Filed: Jun. 26, 2024
(86) PCT No.: PCT/US2024/035506

§ 371 Date: Mar. 10, 2025

Related U.S. Application Data
(60) Provisional application No. 63/512,093, filed on Jul. 6, 2023.

(51) Int. Cl. G01N 25/18

(52) U.S. Cl. CPC G01N 25/18

(57) ABSTRACT

An apparatus for and method of measuring thermal conductivity of a material includes opposed and parallel plates with a gap therebetween for receiving the material. A plate varies a temperature of the material to a predetermined temperature. A linear actuator varies the gap to compress the material to a predetermined load and/or a predetermined thickness. A position sensor is configured to measure a position of the linear actuator. A heat flux sensor measures a heat flux while the material is at the predetermined temperature and at the predetermined load and/or the predetermined thickness.

### CROSS REFERENCE TO RELATED APPLICATION

This application claims priority to and the benefit of U.S. Provisional Patent Application No. 63/512,093, filed Jul. 6, 2023, the entire disclosure of which is incorporated by reference herein.

### FIELD

The invention generally relates to measuring thermal conductivity, and more particularly, to an apparatus for and method of measuring thermal conductivity of an insulative material while said material is at a predetermined temperature and at a predetermined compression load and/or a predetermined compression thickness.

### BACKGROUND

Aerogel blades are a type of insulation that is placed between battery modules in electric vehicles. During a battery cell failure event, the failing battery cell will swell/expand and potentially catch on fire, subjecting adjacent aerogel blades to high temperatures and high pressures. To prevent the conduction of heat from the failing battery cell to nearby battery cells, which could cause those battery cells to also fail (known as thermal runaway), it is important that aerogel blades maintain a low thermal conductivity despite high temperatures and pressures being applied.

Current ASTM test methods to measure thermal conductivity (e.g., ASTM C411, ASTM C518, ASTM C177) include applying a high temperature to the sample; however, these methods do not provide for applying force. Thus, the high pressure applied to the aerogel blade (and the resulting change in the blade's thickness) during a battery cell failure event is not replicated. ASTM C411 is the standard test method used for evaluating hot-surface performance of high temperature insulation. This test method covers the deterioration of the performance (e.g., increased thermal conductivity) of thermal insulating materials when exposed to hot-surface application conditions. However, ASTM C411 requires a fixed sample thickness for the duration of the test and does not provide for applying variable pressure to the test sample. ASTM C518 and ASTM C177 are the standard test methods used for measuring thermal conductivity. The ASTM C518 test set up includes a fixed hot plate and a fixed cold plate with heat flux sensors. This test is used to measure thermal conductivity in any number of different materials of various thicknesses. ASTM C177 works in a similar fashion but measures the electrical power required to maintain the hot plate directly. However, ASTM C518 and C177 require a fixed sample thickness for the duration of the test and do not provide for applying variable pressure to the test sample. Consequently, the insulative performance of aerogel blades during a battery cell failure event cannot be accurately predicted by current test methods.

Accordingly, there is an unmet need to create apparatuses for and methods of measuring thermal conductivity that can replicate the variable high temperatures and variable high pressures of a battery cell failure event, thereby enabling accurate insulative performance prediction of insulative materials subjected to a battery cell failure event.

### SUMMARY

In view of the above, a new apparatus and associated method are proposed for measuring transient or steady state thermal conductivity of an insulative material under variable temperature and pressure load scenarios. The proposed apparatus can control the test thickness of a material sample within hundredths of an inch, apply up to 2,500 pounds of force, and apply temperatures up to 600 °C to simulate a battery cell failure in an EV battery pack. Based on a minimum sample size of about 100 mm×100 mm, the test device can apply a maximum pressure of approximately 145 psi (1 MPa) or more. The apparatus can be used to record the force required to reach and maintain a predetermined thickness (or strain) of the material. The apparatus can also be used to apply a specific force to the material and measure any changes in the material thickness as the apparatus varies a temperature of the material.

The apparatus is a new electromechanical system with novel control software. The apparatus uses a pair of electrically-controlled linear actuators, with position sensors and load sensors, to raise and lower an upper pressing plate. The upper pressing plate comprises a cold side of the thermal conductivity test setup. The upper pressing plate has both temperature and heat flux measurement capabilities. A lower fixed plate comprises a hot side of the thermal conductivity test setup. The lower fixed plate is electrically heated.

The method includes a user placing a sample between the upper pressing plate and the lower fixed plate and specifying at least one of a) a desired test thickness of the sample or b) a desired pressure to apply to the sample. The control software will then either a) utilize the position sensors to control the location of the upper pressing plate to achieve the desired test thickness of the sample and/or b) utilize the load sensors to achieve the desired pressure to apply to the sample. In embodiments of the method, a temperature of the upper pressing plate and a temperature of the lower fixed plate are measured. In embodiments of the method, a heat flux (e.g., a heat flux through a surface of the test sample) is measured.

In view of the above, the general inventive concepts contemplate and encompass thermal conductivity measurement apparatuses and associated methods thereof. The new thermal conductivity measurement apparatuses and methods address problems and/or provide advantages over conventional thermal conductivity measurement methods, such as those provided by ASTM C411, ASTM C518, and ASTM C177.

In embodiments, the apparatus and the method enable thermal conductivity of an insulation sample to be measured and predicted for various combined pressure and temperature load scenarios. The apparatus and the method enable measuring thermal conductivity of a thermal insulation test sample while variable temperatures and pressures are simultaneously applied to the sample. The apparatus and method include means for controlling the position of the pressing plate to vary the thickness of a thermal insulation sample and means for controlling the load applied by the pressing plate to the sample. The apparatus and method are capable of replicating the variable high temperatures and variable high pressures of a battery cell failure event while measuring thermal conductivity of a sample, thereby enabling accurate insulative performance prediction of insulative materials subjected to a battery cell failure event.

Numerous other aspects, advantages, and/or features of the general inventive concepts will become more readily apparent from the following detailed description of exemplary embodiments, from the claims, and from the accompanying drawings being submitted herewith.

### BRIEF DESCRIPTION OF THE DRAWINGS

FIG. 1 is a diagram of an apparatus for measuring thermal conductivity, according to an exemplary embodiment.

FIG. 2 is a diagram of an apparatus for measuring thermal conductivity, according to an exemplary embodiment.

FIG. 3 is a flowchart of a method of measuring thermal conductivity, according to an exemplary embodiment.

### DETAILED DESCRIPTION

While the general inventive concepts are susceptible of embodiment in many different forms, there are shown in the drawings and will be described in detail herein specific embodiments thereof with the understanding that the present disclosure is to be considered merely as an exemplification of the general inventive concepts. Accordingly, the general inventive concepts are not intended to be limited to the specific embodiments illustrated herein.

In some exemplary embodiments, an apparatus 100 may be used to measure thermal conductivity of a material. The apparatus 100 may be configured to vary a temperature of the material to a predetermined temperature; compress the material to a predetermined load and/or a predetermined thickness; and measure a heat flux while the temperature of the material is approximately equal to the predetermined temperature and the material is compressed to the predetermined load and/or the predetermined thickness. In embodiments wherein the apparatus 100 includes means for compressing the material, the means for compressing the material may include means for measuring a position of the means for compressing the material.

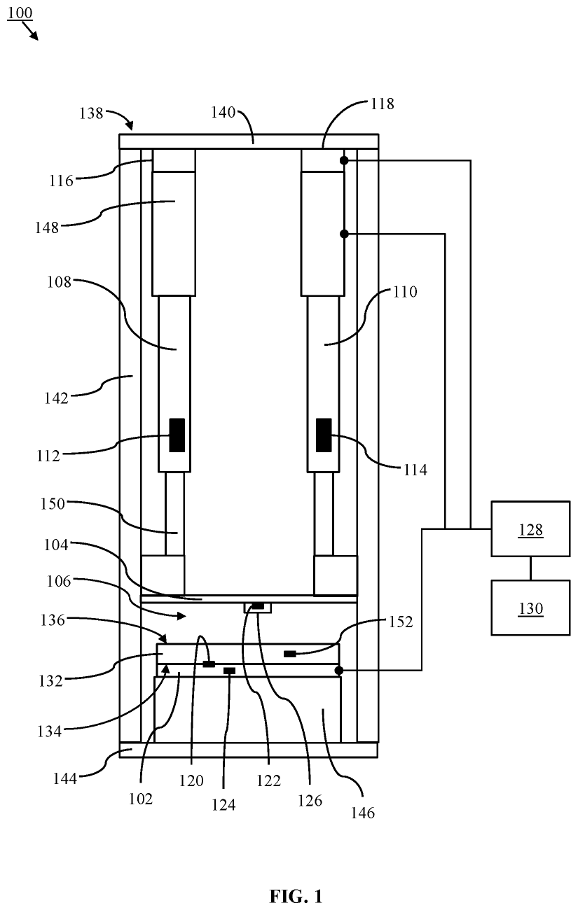

In an exemplary embodiment, the apparatus 100 is shown in FIG. 1. The apparatus 100 includes a first plate 102 and a second plate 104 with a gap 106 therebetween. Furthermore, the apparatus 100 includes a first linear actuator 108 including a first position sensor 112, an upper end 148, and a lower end 150; a second linear actuator 110 including a second position sensor 114; a first load sensor 116; and a second load sensor 118. Further yet, the apparatus 100 includes a first temperature sensor 120; a second temperature sensor 122; a third temperature sensor 124; and a heat flux sensor 126. The apparatus 100 includes a frame 138 having an upper portion 140, a lower portion 144, and a connecting portion 142. The apparatus 100 includes an insulation block 146. The apparatus 100 also includes a controller 128 and a user interface 130. The apparatus 100 is configured to measure a thermal conductivity of a sample 132 (i.e., material, material sample, insulation sample, etc.) having a first surface 134 and a second surface 136.

In an exemplary embodiment, the first plate 102 and the second plate 104 are opposed and substantially parallel to one another with the gap 106 therebetween for receiving the material. The first plate 102 and the second plate 104 may be substantially horizontal relative to a ground plane. In an embodiment, at least one of the first plate 102 and the second plate 104 is movable relative to the other plate. In embodiments, at least one of the first plate 102 and the second plate 104 is made at least partially of aluminum.

In embodiments, at least one of the first plate 102 and the second plate 104 is configured to vary a temperature of the sample 132 to a predetermined temperature. In an embodiment, at least one of the first plate 102 and the second plate 104 includes and/or is thermally coupled to an electric resistance heater. In embodiments, at least one of the first plate 102 and the second plate 104 is capable of varying a temperature of the sample 132 to at least a temperature of 45 °C (e.g., a maximum recommended operating temperature for some EV batteries), 60 °C (e.g., an operating temperature posing an increased risk of thermal runaway for some EV batteries), 100 °C (e.g., an operating temperature posing an extremely critical risk of thermal runaway for some EV batteries), and/or 400 °C (e.g., a temperature at which some EV battery contents may vaporize and cause a fire eruption). In some embodiments, the apparatus 100 may be subjected to temperatures colder than ambient (i.e., less than about 25-28 °C), for example, by placing the apparatus 100 in an environmental chamber.

In exemplary embodiments, the first linear actuator 108 and the second linear actuator 110 are both included in the apparatus 100. It has been discovered that employing two linear actuators in parallel improves stability of the apparatus 100 and increases a maximum compression load that the apparatus 100 is capable of applying. Therefore, employing two linear actuators aids the apparatus 100 in accurately replicating the high pressures experienced by insulative materials in a battery cell failure event.

In exemplary embodiments, the first linear actuator 108 integrally includes the first position sensor 112. The second linear actuator 110 may integrally include the second position sensor 114. In embodiments, the first linear actuator 108 and/or the second linear actuator 110 are configured to vary the gap 106 to compress the sample 132 to at least one of a predetermined load and a predetermined thickness. In embodiments, an end of the first linear actuator 108 and/or an end of the second linear actuator 110 are coupled (e.g., rigidly connected, hingably connected, etc.) to the second plate 104. In embodiments, the end of the first linear actuator 108 and/or the end of the second linear actuator correspond to the lower end 150 that is more proximal to the second plate 104 than the upper end 148.

In exemplary embodiments, the first linear actuator 108, the second linear actuator 110, and/or a combination of the first linear actuator 108 and the second linear actuator 110 is configured to apply a compression load to the sample 132 of at least about 2,600 lbf (11,565 N), 3,000 lbf (13,345 N), or 4,000 lbf (17,793 N). However, as the sample 132 may undergo thermal expansion before and/or during a thermal conductivity measurement (e.g., due to heat received from the first plate 102), in some embodiments it may not be necessary to adjust the linear actuator and/or the second plate 104 in order for the sample 132 to experience a compression load corresponding to the predetermined compression load.

In exemplary embodiments, the first position sensor 112 and/or the second position sensor 114 are configured to measure a position of the linear actuator. The position sensor 112 and/or 114 may be a potentiometer. The first position sensor 112 may be integrated within the first linear actuator 108 and/or measure a stroke of the first linear actuator 108. The second position sensor 114 may be integrated within the second linear actuator 110 and/or measure a stroke of the second linear actuator 110. A position measurement from the position sensor 112 and/or 114 may correspond to a compression thickness of the sample 132.

In some embodiments, the apparatus 100 includes a load sensor, such as the first load sensor 116 and/or the second load sensor 118, wherein the load sensor is configured to measure a load (e.g., force, pressure) applied to the second plate 104 and/or the sample 132. The first load sensor 116 may be coupled to the first linear actuator 108. The second load sensor 118 may be coupled to the second linear actuator. The load sensor may be a load cell.

The load sensor 116 may be disposed between an end (e.g., the upper end 148) of the first linear actuator 108 and the second plate 104. The end of the first linear actuator 108 may be coupled to the first load sensor 116 such that the first load sensor 116 can measure a load applied by the first linear actuator 108 (e.g., the load applied to the second plate 104 while compressing the sample 132).

The second load sensor 118 may be disposed between an end of the second linear actuator 110 (e.g., an end corresponding to the upper end 148 of the first linear actuator 108) and the second plate 104. The end of the second linear actuator 110 may be coupled to the second load sensor 118 such that the second load sensor 118 can measure a load applied by the second linear actuator 110 (e.g., the load applied to the second plate 104 while compressing the sample 132).

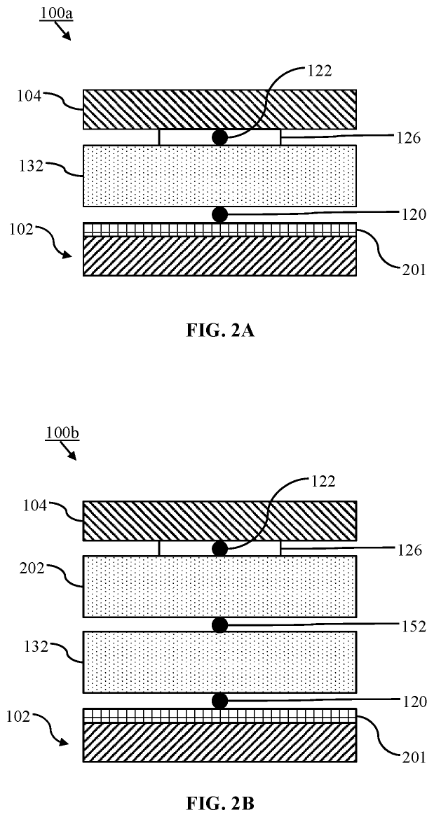

In some embodiments, the apparatus 100 includes a temperature sensor, such as the first temperature sensor 120, the second temperature sensor 122, the third temperature sensor 124, and/or a fourth temperature sensor 152. In embodiments, the first temperature sensor 120 may be disposed between the first plate 102 and the sample 132. The sensor 120 may be fixed to a surface of the first plate 102 that is operable to contact the first surface 134 of the sample 132. In an embodiment where the first plate 102 includes a protective layer (such as protective layer 201 in FIGS. 2A-2B), the sensor 120 may be disposed on the protective layer such that the sensor 120 contacts the first surface 134 of the sample 132 (i.e., such that thermal insulation from the protective layer is excluded from thermal conductivity/resistance calculations for the sample 132). The sensor 120 may be configured to measure a first temperature of the sample 132 (e.g., a hot side temperature). The first temperature may be a temperature of the first surface 134 of the sample 132, for example, in a period before, during, or after the apparatus 100 varies a temperature of the sample 132.

In embodiments, the second temperature sensor 122 may be disposed between the second plate 104 and the sample 132. The sensor 122 may be fixed to a surface of the second plate 104 that is operable to contact the second surface 136 of the sample 132. In embodiments, the sensor 122 is disposed on, at least partially disposed within, or wholly disposed within a heat flux sensor 126. The sensor 122 may be configured to measure a second temperature of the sample 132 (e.g., a cold side temperature). The second temperature may be a temperature of the second surface 136 of the sample 132, for example, in a period before, during, or after the apparatus 100 varies a temperature of the sample 132.

In embodiments, the third temperature sensor 124 may be disposed within the first plate 102. The sensor 124 may be fixed to a surface of the first plate 102, partially disposed on a surface of the first plate 102, partially disposed within the first plate 102, or wholly disposed within the first plate 102. The sensor 124 may be configured to measure a temperature of the first plate 102. In an embodiment wherein the first plate 102 is configured to vary a temperature of the sample 132, the sensor 124 may be configured to measure a temperature of the first plate 102 in a period before, during, or after the first plate 102 varies a temperature of the sample 132. The sensor 124 may be configured to detect when a temperature of the first plate 102 and/or the second plate 104 exceeds a predetermined safety threshold, for example about 700 °C. In such an embodiment, the sensor 124 may be configured to cause an interruption in power supplied to the first plate 102 and/or the second plate 104. For ease of description, features of the at least one plate (unitary or multi-layer) configured to vary a temperature of the sample 132 are sometimes described in relation to the first plate 102, however any feature attributed to the first plate 102 may also be embodied in the second plate 104 and vice versa.

For example, in an embodiment wherein the first plate 102 is configured to vary a temperature of the sample 132, a temperature measurement of the first plate 102 measured by the sensor 124 and received by the controller 128 may cause the controller 128 to interrupt power supplied to the first plate 102. In such an example, interrupting power to the first plate 102 may prevent the first plate 102 from further heating up to unsafe temperatures.

In some embodiments, the apparatus 100 includes a fourth temperature sensor 152 disposed within a sample 132. For example, the sensor 152 may be disposed within a multi-layer sample, such as between layers of the multi-layer sample. The sensor 152 may be configured to measure a third temperature of the sample 132. The third temperature may be an internal temperature of the sample 132, for example, a temperature at an interface between layers of a multi-layer sample. The third temperature may be measured, for example, in a period before, during, or after the apparatus 100 varies a temperature of the sample 132.

In exemplary embodiments, the heat flux sensor 126 is configured to measure a heat flux while the temperature of the sample 132 is approximately equal to the predetermined temperature and the sample 132 is compressed to at least one of the predetermined load and the predetermined thickness. In embodiments, the heat flux sensor 126 is disposed on or within the second plate 104. The sensor 126 may be mounted approximately at the center of a surface (e.g., a lower surface) of the second plate 104. In embodiments, the heat flux sensor 126 may be disposed between the second plate 104 and the sample 132. The heat flux sensor 126 may be fixed to a surface of the second plate 104 that is operable to contact the second surface 136 of the sample 132. The heat flux sensor 126 may be configured to measure a heat flux of the sample 132. The heat flux may be a heat flux through the second surface 136 of the sample 132, for example, in a period before, during, or after the apparatus 100 varies a temperature of the sample 132.

In exemplary embodiments, the controller 128 is in communication with at least one of the elements of the apparatus 100, such as the linear actuator(s), the position sensor(s), the load sensor(s), the temperature sensor(s), and/or the heat flux sensor(s). The controller 128 may utilize wireless or wired communication means to communicate with any of the elements of the apparatus 100. The controller 128 may be programmed (e.g., by software) to perform as claimed.

In exemplary embodiments, the controller 128 is configured to control at least one of the first plate 102 and the second plate 104 to vary the temperature of the sample 132 to the predetermined temperature. In an embodiment wherein the first plate 102 is configured to vary the temperature of the sample 132, the controller 128 may selectively permit power to be supplied to the first plate 102 in order to vary the temperature of the first plate 102. In embodiments, the first plate 102 may include a resistive heater to heat the first plate such that a temperature of the sample 132 (e.g., a temperature of the first surface 134 of the sample 132) corresponds to the predetermined temperature. In embodiments, the first plate 102 may include a thermoelectric device (e.g., a Peltier heater/cooler) to heat and/or cool the first plate such that a temperature of the sample 132 corresponds to the predetermined temperature. The second plate 104 may be cooled, such as by natural or forced convective cooling (e.g., air cooled).

The first plate 102 may be a hot plate assembly comprising an upper plate and a lower plate that may each comprise stainless steel. One or more layers of mica insulation may be disposed between the upper plate and the lower plate. At least one layer of mica insulation (e.g., a center layer amongst a plurality of layers) may be wrapped with a resistive heater wire. The resistive heater wire may receive power from a power source relay (e.g., a 48 VDC relay) that may be actuated by the controller 128. One or more temperature sensors (e.g., thermocouples) may be embedded within the first plate 102. For example, a temperature sensor may be configured to communicate a temperature measurement of the first plate 102 to the controller 128 to permit monitoring and selectively varying a temperature of the first plate 102 and/or to permit interruption of power (e.g., by actuating the power source relay) to the resistive heater wire, for example, when a temperature of the first plate 102 exceeds a predetermined threshold.

The first plate 102 and/or the second plate 104 may include a protective coating or layer (such as protective layer 201 shown in FIGS. 2A-2B) on a surface of the plate(s) that would otherwise contact the sample 132. Including such a protective coating or layer may protect the plate(s) from being fouled by a melting or deteriorating sample 132, which would require cleaning or replacement of the plate(s) to ensure measurements are unaffected. For example, the hot plate assembly comprising the first plate 102 may include a protective layer comprising mica. The mica sheet may be about 0.5 mm (0.020 inches) thick, and the apparatus (e.g., position sensors of the linear actuators) may be tared with the sheet of mica in place (i.e., such that the measured thickness of the sample 132 is not skewed by the thickness of the mica sheet).

In exemplary embodiments, the controller 128 is configured to receive a temperature measurement from a temperature sensor (e.g., temperature sensor 120, 122, 124, and/or 152). The temperature measurement may correspond to a temperature of a surface (e.g., the first surface 134) of the sample 132. The controller may be configured to control the first plate 102 to heat a surface (e.g., the first surface 134) of the sample 132 such that the temperature measurement corresponds to (e.g., is approximately equal to) the predetermined temperature.

In exemplary embodiments, the controller 128 is configured to receive a measurement from a load sensor (e.g., load sensor 116 and/or 118) and/or a position sensor (e.g., position sensor 112 and/or 114). In embodiments, the controller 128 is configured to simultaneously control the first linear actuator 108 and the second linear actuator 110 such that measurements from the position sensor 112 and/or 114 correspond to the predetermined thickness. In exemplary embodiments, the controller 128 is configured to receive a heat flux measurement from the heat flux sensor 126.

In exemplary embodiments, the controller 128 is configured to adjust a linear actuator (e.g., linear actuator 108 and/or 110) to move the second plate 104 toward the first plate 102 to vary the gap 106. Varying the gap 106 may cause the material to be compressed to the predetermined load and/or predetermined thickness. In an embodiment, the controller 128 causes the linear actuator to lower the second plate 104 toward the first plate 102, thereby reducing a vertical size of the gap 106. In an embodiment, the controller 128 causes the linear actuator to raise the second plate 104 away from the first plate 102, thereby increasing the vertical size of the gap 106. Selectively reducing and/or increasing the vertical size of the gap 106 allows the material to be compressed to the predetermined load and/or the predetermined thickness.

In exemplary embodiments, the controller 128 is configured to receive at least one of a predetermined minimum test interval (i.e., a minimum step time for recording one or more measurements at a temperature, load, and/or thickness), predetermined temperature, the predetermined load, and the predetermined thickness (i.e., the predetermined setpoints). In embodiments, a user may input at least one of the predetermined setpoints into the user interface 130. In such embodiments, the controller 128 may be configured to receive at least one of the predetermined setpoints from the user interface 130. In embodiments, at least one of the predetermined setpoints may be automatically or manually generated by a computer program and/or an equation.

In exemplary embodiments, the controller 128 is configured to calculate an instantaneous or steady state thermal resistance of the sample 132 based on the inputs it has received (i.e., a hot side temperature measurement, a cold side temperature measurement, and a heat flux measurement). The controller 128 may be configured to calculate an instantaneous or steady state thermal conductivity of the sample 132 based on the inputs it has received (i.e., a hot side temperature, a cold side temperature, a heat flux measurement, and a thickness of the sample). The controller may be configured to output the thermal resistance and/or the thermal conductivity to the user interface 130.

In exemplary embodiments, the apparatus 100 includes the frame 138, wherein the frame 138 may include the upper portion 140, the lower portion 144, and the connecting portion 142. The connecting portion 142 may extend between and structurally connect the upper portion 140 and the lower portion 144. The frame 138 may enclose and/or support any of the elements of the apparatus 100, such as the first plate 102, the second plate 104, the temperature sensor (e.g., temperature sensor 120, 122, 124, and/or 152), the linear actuator (e.g., actuator 108 and/or 110), the load sensor (e.g., sensor 116 or 118), and/or the heat flux sensor 126. The frame 138 may enclose and/or support the controller 128 and/or the user interface 130.

The second plate 104 may be movably coupled to the frame 138. For example, the second plate 104 may be slidably mounted to the connecting portion 142 of the frame 138 such that the linear actuator can raise and/or lower the second plate 104 in a direction parallel to the connecting portion 142. The first plate 102 may be fixed to the frame 138, such as to the lower portion 144. The insulation block 146 may be disposed between the first plate 102 and the lower portion 144 of the frame 138. In such an arrangement, the insulation block 146 may limit heat from escaping a side of the first plate 102 that is not adjacent to the first surface 134 of the sample 132. In exemplary embodiments, standoffs (e.g., ceramic standoffs, rigid standoffs, etc.) may extend from the lower portion 144 through the insulation block 146 and be coupled to the first plate 102. In such an embodiment, the standoffs may function to rigidly support and/or connect the first plate 102 to the lower portion 144 of the frame 138 while reducing heat loss from the first plate 102 to the frame 138. In embodiments, portions of the frame 138 may be made of aluminum.

In exemplary embodiments, the load sensor 116 and/or 118 may be fixed to the upper portion 140 of the frame 138. In an embodiment, the first load sensor 116 may be disposed between an end of the first linear actuator 108 and a portion of the frame 138, such as the upper portion 140. The end of the first linear actuator 108 may be the upper end 148 that is more distal to the second plate 104 than lower end 150. The load sensor 118 may be disposed between an end of the second linear actuator 110 and a portion of the frame 138, such as the upper portion 140. In an embodiment, the end of the second linear actuator 110 may be an upper end that is distal to the second plate 104.

In exemplary embodiments, the apparatus 100 includes the first linear actuator 108 and the second linear actuator 110. The controller 128 may be configured to substantially simultaneously control the first linear actuator 108 and the second linear actuator 110 to vary the gap 106 to compress the sample 132 to at least one of the predetermined load and the predetermined thickness. In embodiments, the first position sensor 112 is configured to measure a first position of the first linear actuator 108. The second position sensor 114 may be configured to measure a second position of the second linear actuator 110. The controller 128 may be configured to receive a first position measurement from the first position sensor 112, wherein the first position measurement may correspond to the first position of the first linear actuator 108. The controller 128 may be configured to receive a second position measurement from the second position sensor 114, wherein the second position measurement may correspond to the second position of the second linear actuator 110. The controller 128 may be configured to control (e.g., via pulse-width modulation or PWM control) the first linear actuator 108 and/or the second linear actuator 110 such that the first position measurement and the second position measurement are approximately equal, such as during an adjustment period of the linear actuators and/or during a measurement period (e.g., a temperature measurement period, a heat flux measurement period, a linear actuator position measurement period, a sample thickness measurement period, a compression load measurement period, etc.). It has been discovered that utilizing two independent linear actuators, each having a position sensor and each in communication with the controller 128, allows the apparatus 100 to compress the sample 132 with higher amounts of force than conventional test methods and systems while precisely controlling a thickness of the sample 132 (e.g., within tenths of an inch, within hundredths of an inch, within thousandths of an inch, etc. of a predetermined thickness).

The first load sensor 116 may be coupled to the first linear actuator 108, and the sensor 116 further may be configured to measure a first load applied to the sample 132. The second load sensor 118 may be coupled to the second linear actuator 110, and the sensor 118 further may be configured to measure a second load applied to the sample 132. The controller 128 may be configured to receive a first load measurement from the first load sensor 116, wherein the first load measurement may correspond to the first load applied by the first linear actuator 108. The controller 128 may be configured to receive a second load measurement from the second load sensor 118, wherein the second load measurement may correspond to the second load applied by the second linear actuator 110. The controller 128 may be configured to control the first linear actuator 108 and/or the second linear actuator 110 such that the first load measurement and the second load measurement are approximately equal, such as during the adjustment period of the linear actuators and/or during any of the measurement periods. It has been discovered that utilizing two independent linear actuators, each coupled to a load sensor and each in communication with the controller 128, allows the apparatus 100 to compress the sample 132 with higher amounts of force than conventional test methods and systems while precisely controlling a compression load applied to the sample 132 (e.g., within five newtons, a newton, tenths of a newton, etc. of a predetermined load).

In exemplary embodiments, the apparatus 100 is configured to measure a thermal conductivity of the sample 132. In embodiments, the sample 132 may be compressible, insulative, and/or fibrous. The sample 132 may include aerogel particles. In embodiments, the sample 132 includes the first surface 134 and the second surface 136. The first surface 134 and the second surface 136 may be opposite one another. A distance from the first surface 134 to the second surface 136 may represent a thickness of the sample 132. In embodiments, the first plate 102 is operable to contact the first surface 134 of the sample 132. In embodiments, the second plate 104 is operable to contact the second surface 136 of the sample 132. Selectively reducing and/or increasing the vertical size of the gap 106 may compress the sample 132 such that the second surface 136 is brought closer to the first surface 134, thereby allowing the sample 132 to be compressed to the predetermined load and/or the predetermined thickness.

In an exemplary embodiment, the apparatus 100 is shown in FIGS. 2A and 2B. A protective layer 201 as discussed herein is shown in FIGS. 2A and 2B. FIG. 2A shows apparatus 100a without the interface 202 shown in FIG. 2B. Apparatus 100a may be suitable where a test requires a low mean temperature (i.e., a relatively low average temperature of the hot side temperature and cold side temperature). The apparatus 100b shown in FIG. 2B that includes the interface 202 may be more suitable for test scenarios that require a high mean temperature.

The interface 202 is generally an insulative material disposed between the sample 132 and the heat flux sensor 126 such that the cold side temperature measured by the second temperature sensor 122 is higher than what it would be without the interface 202. The interface 202 may have a compressible strength that is substantially similar to that of the sample 132. If the stiffness of the interface 202 and the sample 132 are similar, the strain may be assumed to be similar between the interface 202 and the sample 132. Such a configuration may enable the thermal conductivity of the sample 132 to be more accurately determined. In an embodiment, the interface 202 may comprise the same material as the sample 132.

A temperature sensor (e.g., the fourth temperature sensor 152) may be disposed between the sample 132 and the interface 202. The fourth temperature sensor 152 may record and/or communicate a temperature measurement (i.e., a middle temperature) to the controller 128 and/or the user interface 130. This temperature measurement may be used by the controller 128 to calculate a thermal conductivity of the sample 132 (i.e., this middle temperature may be used in lieu of the cold-side temperature from the second temperature sensor 122 such that the mean temperature of the middle temperature and the hot side temperature is higher than that of the mean temperature of the cold side temperature and the hot side temperature). When such a configuration is at steady state, the heat flux through the sample 132 is approximately equal to the heat flux through the stack comprising the apparatus (i.e., heat flowing from plate 102 to plate 104).

In some exemplary embodiments, a method 300 for measuring thermal conductivity of a sample (i.e., material, material sample, insulation sample, etc.) involves varying a temperature of the sample to a predetermined temperature; compressing the sample to a predetermined load and/or a predetermined thickness; and measuring a heat flux of the sample while at the predetermined temperature and at the predetermined load and/or the predetermined thickness.

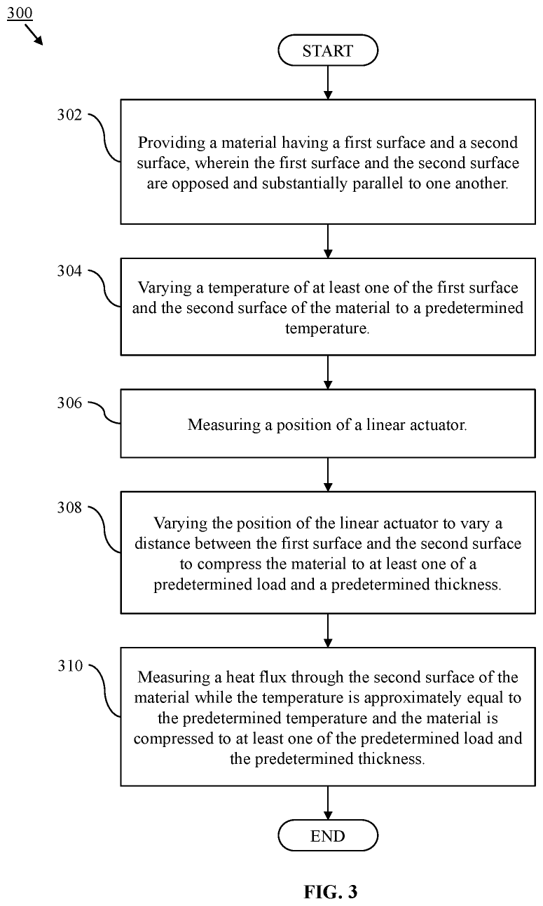

In an exemplary embodiment, a method 300 for measuring thermal conductivity is shown in FIG. 3. The method 300 includes providing a material having a first surface and a second surface, wherein the first surface and the second surface are opposed and substantially parallel to one another 302; varying a temperature of at least one of the first surface and the second surface of the material to a predetermined temperature 304; measuring a position of a linear actuator 306; varying the position of the linear actuator to vary a distance between the first surface and the second surface to compress the material to at least one of a predetermined load and a predetermined thickness 308; and measuring a heat flux through the second surface of the material while the temperature is approximately equal to the predetermined temperature and the material is compressed to at least one of the predetermined load and the predetermined thickness 310.

In an exemplary embodiment, the method 300 includes varying the temperature of at least one of the first surface and the second surface to a second predetermined temperature. The method 300 may include measuring a second heat flux through the second surface of the material while the temperature of the material is approximately equal to the second predetermined temperature.

In an exemplary embodiment, the method 300 includes varying the position of the linear actuator to vary the distance between the first surface and the second surface to compress the material to at least one of a second predetermined load and a second predetermined thickness (i.e., to a second predetermined load and/or a second predetermined thickness.

In an exemplary embodiment, the method 300 includes measuring a load applied to the material. In such an embodiment, the method 300 may further include comparing the load applied to the predetermined load. The result of the comparison between the load applied and the predetermined load may be a load error. In an embodiment, the method 300 includes comparing the position of the linear actuator to the predetermined thickness. The result of the comparison between the position of the linear actuator and the predetermined thickness may be a position error. The load error and/or the position error may be generally referred to as an error amount.

The method 300 may include adjusting an adjustment speed (e.g., via pulse-width modulation or PWM control) of the linear actuator. In an example, the method 300 may include proportionally adjusting the adjustment speed of the linear actuator based on the error amount (e.g., load error and/or position error). In an example, the method 300 may include increasing the adjustment speed based on a larger error amount and/or decreasing the adjustment speed based on a smaller error amount. The adjustment speed may be increased up to a maximum speed of about 7.6 millimeters per second and decreased down to a minimum speed approaching about 0 millimeters per second.

A method of measuring a first thermal conductivity and a second thermal conductivity of the sample 132 may comprise collecting a temperature of a first surface 134 of the sample 132; collecting at least one of a compression thickness of the sample 132 and/or a compression load applied to the sample 132; and collecting a first heat flux through the second surface 136 of the sample 132. The method may include substantially simultaneously collecting at least two of the temperature, the compression thickness, the compression load, and the first heat flux. The method may further comprise varying at least one of the temperature, the compression thickness, and the compression load. In such an embodiment, the method may further comprise collecting a second heat flux through the second surface of the material. In an embodiment, the first thermal conductivity is measured while a temperature of the sample 132 is approximately equal to a minimum test temperature (e.g., about 50 °C). The second thermal conductivity may be measured while the temperature of the sample 132 is at a temperature greater than the minimum test temperature (e.g., about 100 °C). The second thermal conductivity may be measured while the temperature of the sample 132 is approximately equal to a maximum test temperature, for example, about 400 °C or more, such as up to about 677 °C. Testing the sample first at a minimum test temperature and then increasing the test temperature in successive measurements may maximize the number of measurements that may be collected from the sample before the sample is damaged, thereby potentially risking unreliable or skewed test results.

In an exemplary embodiment, the sample 132 is compressed to a thickness of about 5 mm. A first surface 134 of the sample 132 is heated to a first temperature such as about 50 °C. Once the temperature of a second surface 136 is steady (e.g., five repeated measurements are within 5% of each other) and non-monotonic (i.e., not slowly and/or steadily changing temperature over time), one or more first measurements (e.g., a temperature, load, thickness, and/or heat flux) is recorded. In embodiment, a plurality of first measurements (e.g., a plurality of heat fluxes) may be recorded during a predetermined minimum test interval. The minimum test interval may be input by a user via the user interface 130. For example, the minimum test interval may be about 15 minutes. A portion of the plurality of heat fluxes may be recorded, for example, over a sub-interval of five minutes. The controller 128 may calculate a sub-interval average of the portion of the plurality of heat fluxes.

At the conclusion of the predetermined minimum test interval, a portion of the first measurements, such as the last five first measurements, may be averaged together and stored as a final result for that test interval (e.g., by the controller 128) and/or output to the user interface 130. A first thermal conductivity of the sample 132 may be calculated (e.g., by the controller 128) using any of the aforementioned first measurements. For example, the first thermal conductivity may be calculated using the final result of the test interval. In such an embodiment, the final result may comprise the averages of the last five measurements of the first heat flux as well as one or more temperatures of (e.g., the measured temperatures of the first surface 134 and/or the second surface 136), a thickness of, and/or a load applied to the sample. Then, the first surface 134 is heated to a temperature greater than the first temperature, and a second heat flux is recorded according to the process set forth above. However, the first surface 134 may alternatively be cooled to a temperature lower than the first temperature. A second thermal conductivity of the sample 132 may be calculated using the second heat flux(es) and the newly measured temperatures of the first surface 134 and/or the second surface 136.

In an exemplary embodiment, the sample 132 is compressed to a thickness of about 5 mm. A first surface 134 of the sample 132 is heated to a first temperature such as about 677 °C. Once the temperature of a second surface 136 is steady (e.g., five repeated measurements are within 5% of each other) and non-monotonic (i.e., not slowly and/or steadily changing temperature over time), a first heat flux is recorded and a first thermal conductivity of the sample 132 may be calculated using the first heat flux and the measured temperatures of the first surface 134 and/or the second surface 136. Then, the first surface 134 is cooled to a temperature lower than the first temperature, and a second heat flux is recorded according to the process set forth above. However, the first surface 134 may alternatively be heated to a temperature higher than the first temperature. A second thermal conductivity of the sample 132 may be calculated using the second heat flux and the newly measured temperatures of the first surface 134 and/or the second surface 136.

In embodiments, the sample 132 may be further compressed by 25% (i.e., the thickness of the sample 132 is compressed to 75% of 5 mm), and the above steps for determining the first and second heat fluxes may be repeated for determining third and fourth thermal conductivities at the new compression thickness. In embodiments, instead of or in addition to being compressed to a predetermined thickness, the sample 132 may be compressed by a predetermined load.

In embodiments, upon completion of a test, the apparatus 100 may be programmed to position the second plate 104 such that it remains in contact with the sample 132 at least until the sample 132 and/or until the first plate 102 has cooled to a safe temperature (e.g., about 85 °C or less, about 60 °C or less, about 50 °C or less, about 25 °C or less, etc.). For example, the apparatus 100 may be programmed to apply a minimum load, such as about 50 lbf or less. After the sample 132 and/or the first plate has cooled to the safe temperature, the apparatus 100 may raise the second plate 104 such that it is no longer in contact with the sample 132 (e.g., there is a gap between the second plate 104 and the sample 132, where the gap may be about 50 mm or more). Such a feature of the disclosed method may reduce the risk of a test operator being burned by the sample 132 and/or the apparatus 100. This feature may also make it easy for an operator to see that a test is complete, that the sample 132 may be removed, and/or that the apparatus 100 is ready to receive and test a second sample.

In exemplary embodiments, the apparatus 100, 200 and/or the method 300 may be used to generate a curve of the determined thermal conductivities (e.g., the first, second, third, and fourth thermal conductivities) to predict thermal conductivity performance, and therefore insulative performance, of a sample 132 when subjected to any temperature (e.g., heated to a higher temperature by a failing battery cell) and/or strain (e.g., compressed to a smaller thickness due to a swelling battery cell).

The apparatuses for and methods of measuring thermal conductivity as disclosed or otherwise suggested herein (e.g., apparatus 100, 200; method 300) have certain improved capabilities for measuring thermal conductivity while simultaneously applying a predetermined temperature and a predetermined compression load and/or compression thickness. The apparatuses and methods allow for more quickly testing thermal conductivity of a material sample under several load cases with varying temperatures, compression loads, and/or compression thicknesses that can accurately replicate high-temperature and high-pressure scenarios, such as a battery cell failure event. For example, using the apparatuses and/or methods herein, up to 12 thermal conductivity values at varying temperatures and varying strains can be determined for a sample in a period of about 24 hours or less. Conventional methods require 24 hours to determine a single thermal conductivity data point of a sample at a single temperature, and furthermore, the conventional methods are not capable of varying strains applied to the sample. In a further advantage of the apparatuses and methods herein, generating several data points for thermal conductivity of a material sample under varying temperatures and varying strains allows for more accurately predicting insulative performance of the material when submitted to other scenarios that have not been explicitly tested. Thus, insulative materials (e.g., aerogel blades used to insulate battery modules in electric vehicles) can be designed and validated to achieve insulative performance requirements in harsh conditions without explicitly recreating said conditions (e.g., igniting a battery cell, thereby creating an unsafe testing environment).

It will be appreciated that the scope of the general inventive concepts is not intended to be limited to the particular exemplary embodiments shown and described herein. From the disclosure given, those skilled in the art will not only understand the general inventive concepts and their attendant advantages but will also find apparent various changes and modifications to the methods and systems disclosed. It is sought, therefore, to cover all such changes and modifications as fall within the spirit and scope of the general inventive concepts, as described and claimed herein, and any equivalents thereof. For example, while some exemplary embodiments shown and described herein include one linear actuator or a pair of linear actuators, the general inventive concepts are not so limited and instead may include any number of linear actuators and associated position sensors, load sensors, etc.

1. An apparatus for measuring a thermal conductivity of a material, the apparatus comprising:
a first plate;
a second plate;
a linear actuator including a position sensor; and
a heat flux sensor;
wherein the first plate and the second plate are opposed and substantially parallel to one another with a gap therebetween for receiving the material;
wherein at least one of the first plate and the second plate is configured to vary a temperature of the material to a predetermined temperature;
wherein the linear actuator is configured to vary the gap to compress the material to at least one of a predetermined load and a predetermined thickness;
wherein the position sensor is configured to measure a position of the linear actuator; and
wherein the heat flux sensor is configured to measure a heat flux while the temperature is approximately equal to the predetermined temperature and the material is compressed to at least one of the predetermined load and the predetermined thickness.

2. The apparatus of claim 1, further comprising a controller configured to:
control at least one of the first plate and the second plate to vary the temperature of the material to the predetermined temperature;
receive a temperature measurement from a temperature sensor;
receive a measurement from at least one of a load sensor and the position sensor;
receive a heat flux measurement from the heat flux sensor; and
adjust the linear actuator to move the second plate toward the first plate to vary the gap to compress the material to at least one of the predetermined load and the predetermined thickness.

3. (canceled)

4. The apparatus of claim 1, wherein the heat flux sensor is disposed between the second plate and the material, wherein the heat flux sensor is configured to measure the heat flux through a surface of the material.

5. The apparatus of claim 1, further comprising a temperature sensor disposed between the first plate and the material, wherein the temperature sensor is configured to measure a temperature of the material.

6. The apparatus of claim 1, further comprising a temperature sensor disposed between the second plate and the material, wherein the temperature sensor is configured to measure a temperature of the material.

7. The apparatus of claim 1, further comprising a temperature sensor disposed within at least one of the first plate and the second plate, wherein the temperature sensor is configured to measure a temperature of the at least one of the first plate and the second plate.

8. The apparatus of claim 7, wherein the temperature sensor is configured to cause an interruption in power supplied to the at least one of the first plate and the second plate if the temperature of the at least one of the first plate and the second plate exceeds a predetermined threshold.

9. The apparatus of claim 1, further comprising a temperature sensor disposed within the material, wherein the temperature sensor is configured to measure an internal temperature of the material.

10. The apparatus of claim 1, further comprising a load sensor coupled to the linear actuator, wherein the load sensor is configured to measure a load applied to the material.

11. The apparatus of claim 1, wherein the material comprises a first surface and a second surface; wherein the first surface and the second surface are opposite one another; wherein a distance from the first surface to the second surface represents a thickness of the material; wherein the first plate is operable to contact the first surface of the material; and wherein the second plate is operable to contact the second surface of the material.

12. An apparatus for measuring a thermal conductivity of a material, the apparatus comprising:
a first plate;
a second plate;
a first linear actuator including a first position sensor;
a second linear actuator including a second position sensor;
a heat flux sensor; and
a controller;
wherein the first plate and the second plate are opposed and substantially parallel to one another with a gap therebetween for receiving the material;
wherein at least one of the first plate and the second plate is configured to vary a temperature of the material to a predetermined temperature;
wherein the controller is configured to control the first linear actuator and the second linear actuator to vary the gap to compress the material to at least one of the predetermined load and the predetermined thickness;
wherein the first position sensor is configured to measure a first position of the first linear actuator;
wherein the second position sensor is configured to measure a second position of the second linear actuator; and
wherein the heat flux sensor is configured to measure a heat flux while the temperature is approximately equal to the predetermined temperature and the material is compressed to at least one of the predetermined load and the predetermined thickness.

13. The apparatus of claim 12, wherein the controller is configured to:
receive a first position measurement from the first position sensor,
receive a second position measurement from the second position sensor, and
control the first linear actuator and the second linear actuator such that the first position measurement and the second position measurement are approximately equal.

14. The apparatus of claim 12, further comprising:
a first load sensor coupled to the first linear actuator, and
a second load sensor coupled to the second linear actuator;
wherein the first load sensor is configured to measure a first load applied to the material, and
wherein the second load sensor is configured to measure a second load applied to the material.

15. The apparatus of claim 14, wherein the controller is configured to:
receive a first load measurement from the first load sensor,
receive a second load measurement from the second load sensor, and
control the first linear actuator and the second linear actuator to vary the gap to compress the material to the predetermined load;
wherein the first load measurement is approximately equal to the second load measurement.

16-17. (canceled)

18. A method of measuring a thermal conductivity of a material, the method comprising:
providing the material,
wherein the material has a first surface and a second surface, and
wherein the first surface and the second surface are opposed and substantially parallel to one another;
varying a temperature of at least one of the first surface and the second surface of the material to a first predetermined temperature;
compressing the material to at least one of a first predetermined load and a first predetermined thickness; and
measuring a first heat flux through the second surface of the material while the temperature is approximately equal to the first predetermined temperature and the material is compressed to at least one of the first predetermined load and the first predetermined thickness.

19. The method of claim 18, further comprising:
varying the temperature of at least one of the first surface and the second surface to a second predetermined temperature; and
measuring a second heat flux through the second surface of the material while the temperature is approximately equal to the second predetermined temperature.

20. The method of claim 18, further comprising:
compressing the material to at least one of a second predetermined load and a second predetermined thickness; and
measuring a second heat flux through the second surface of the material while the material is compressed to at least one of the second predetermined load and the second predetermined thickness.

21. The method of claim 18, wherein compressing the material to the at least one of the first predetermined load and the first predetermined thickness includes measuring a position of a linear actuator and varying the position of the linear actuator to vary a distance between the first surface and the second surface of the material.

22. The method of claim 21, further comprising measuring a load applied to the material, comparing the load applied to the predetermined load, and adjusting an adjustment speed of the linear actuator.

23. The method of claim 21, further comprising comparing the position of the linear actuator to the predetermined thickness and adjusting an adjustment speed of the linear actuator.
